(19) United States
(12) Patent Application Publication
(10) Pub. No.: US 2007/0039013 A1
(43) Pub. Date: Feb. 15, 2007

(54) Carrying mechanism and optical disc drive using the same

(75) Inventors: Xiao-Ning Sun, Suzhou (CN); Hsien-Tsung Chiu, Gueishan Township (TW); Meng-Yu Wu, Sihhu Township (TW)

Correspondence Address: RABIN & Berdo, PC, 1101 14TH STREET, NW, SUITE 500, WASHINGTON, DC, 20005, US

(73) Assignee: BenQ Corporation

(21) Appl. No.: 11/498,091

(22) Filed: Aug. 3, 2006

(30) Foreign Application Priority Data
Aug. 11, 2005 (TW) 94127397

(51) Int. Cl. G11B 17/04

(52) U.S. Cl. 720/610

(57) ABSTRACT

An optical disc drive includes an optical pickup unit and a carrying mechanism. The optical pickup unit has a first clamping portion and a second clamping part. The carrying mechanism includes a mounting plate, a first guiding component and a second guiding component. The mounting plate has a locking hole. At least one of the first guiding component and the second guiding component is a plate structure and has a hook. The hook is plugged into the locking hole for enabling the first guiding component or the second guiding component to be engaged with the mounting plate. The first clamping portion or the second clamping portion is respectively coupled to the first guiding component or the second guiding component for sliding the optical pickup unit along a first direction.

This application claims the benefit of Taiwan application Serial No. 94127397, filed on Aug. 11, 2005, the subject matter of which is incorporated herein by reference.

### BACKGROUND OF THE INVENTION

1. Field of the Invention

The invention relates in general to a carrying mechanism and an optical disc drive using the same, and more particularly to a slidable carrying mechanism and an optical disc drive using the same.

2. Description of the Related Art

As the digital media and information industry advances rapidly, digital contents and audio/video products become more enjoyable and convenient to the users. Optical disc drive which provides the read/write functions of a large amount of digital data as well as the store/play functions of audio/video data such as music or movies has become one of the indispensable electronic devices to modern people in their daily lives.

Referring to FIG. 1, an optical pickup unit and a carrying mechanism of a conventional optical disc drive are shown. The conventional optical disc drive includes an optical pickup unit 50 and a carrying mechanism 120. The optical pickup unit 50 includes a first clamping portion 51 and a second clamping portion 52. The carrying mechanism 120 includes a mounting plate 23, a first guiding component 21 and a second guiding component 122. The first guiding component 21 and the second guiding component 122, which are used for fixing a screw 123 on the mounting plate 23, are parallel to each other. The first clamping portion 51 and the second clamping portion 52 of the optical pickup unit 50 can be respectively coupled to the first guiding component 21 and the second guiding component 122 for enabling the optical pickup unit 50 to slide on the mounting plate 23.

The bar-structured conventional first guiding component 21 and second guiding component 122 are made of metals which are more costive than other materials. The conventional carrying mechanism 120 locks the first guiding component 21 and the second guiding component 122 on the mounting plate 23 via the screw 123, increasing not only material cost but also the labor of screwing the screw during manufacturing process. Moreover, when the optical disc drive is in use, the optical pickup unit 50 is likely to be damaged when the optical pickup unit 50 slides on the carrying mechanism 120 due to the lack of buffer. Given that both the first guiding component 21 and the second guiding component 122 are made of hard metal material, and that the carrying mechanism 120 uses the screw 123 to lock the first guiding component 21 and the second guiding component 122, no buffer is provided.

### SUMMARY OF THE INVENTION

It is therefore an object of the invention to provide a carrying mechanism and an optical disc drive using the same. The invention substitutes plastics for the metal material of the first guiding component or the second guiding component. The first guiding component or the second guiding component is disposed on the mounting plate via an engaging mechanism instead of a screw. As a result, both the material cost and the labor of locking the screw are reduced. Furthermore, in the carrying mechanism, an elastomer is disposed on the first guiding component or the second guiding component for reducing the impact received by the optical pickup unit when in use.

The invention achieves the above-identified object by providing a carrying mechanism for carrying an object. The object includes a first clamping portion and a second clamping part. The carrying mechanism includes a mounting plate, a first guiding component and a second guiding component. The mounting plate has a locking hole. The first guiding component and the second guiding component are disposed on the mounting plate. At least one of the first guiding component and the second guiding component has a hook. At least one of the first guiding component and the second guiding component is a plate structure and has a first surface. The hook protruded from the first surface is plugged into the locking hole for enabling the first guiding component or the second guiding component to be engaged with the mounting plate. The first clamping portion or the second clamping portion is respectively coupled to the first guiding component or the second guiding component for enabling the object to slide along a first direction.

The invention further achieves the above-identified object by providing an optical disc drive. The optical disc drive includes an optical pickup unit and a carrying mechanism. The optical pickup unit has a first clamping portion and a second clamping part. The carrying mechanism includes a mounting plate, a first guiding component and a second guiding component. The mounting plate has a locking hole. The first guiding component and the second guiding component are disposed on the mounting plate. At least one of the first guiding component and the second guiding component has a hook. At least one of the first guiding component and the second guiding component is a plate structure and has a first surface. The hook protruded from the first surface is plugged into the locking hole for enabling the first guiding component or the second guiding component to be engaged with the mounting plate. The first clamping portion or the second clamping portion is respectively coupled to the first guiding component or the second guiding component for enabling the object to slide along a first direction.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates an optical pickup unit and a carrying mechanism of a conventional optical disc drive;

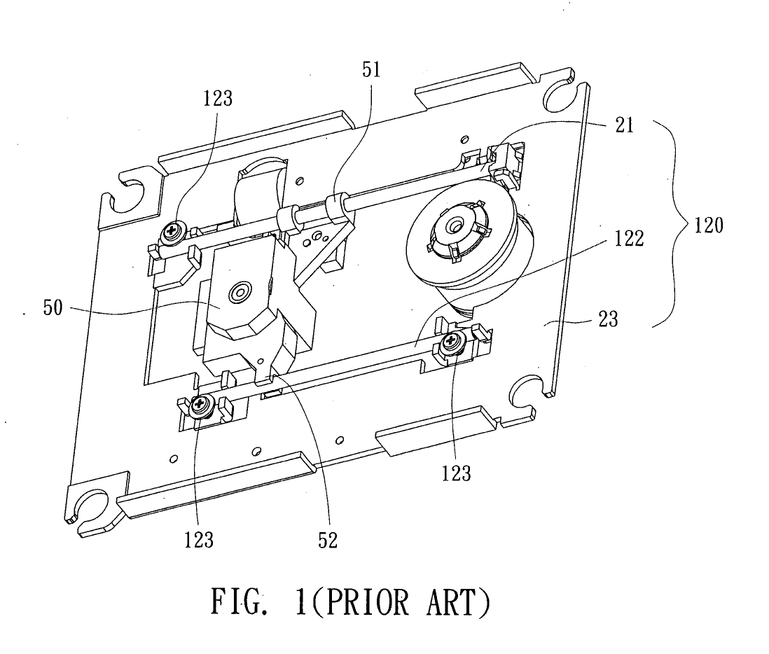

FIG. 2 illustrates the optical pickup unit and the carrying mechanism of an optical disc drive according to a preferred embodiment of the invention;

FIG. 3 is an enlarged diagram of the second guiding component in FIG. 2;

FIG. 4 illustrates the mounting plate in FIG. 2; and

FIG. 5 illustrates a rear view of the optical pickup unit and the carrying mechanism in FIG. 2.

### DETAILED DESCRIPTION OF THE INVENTION

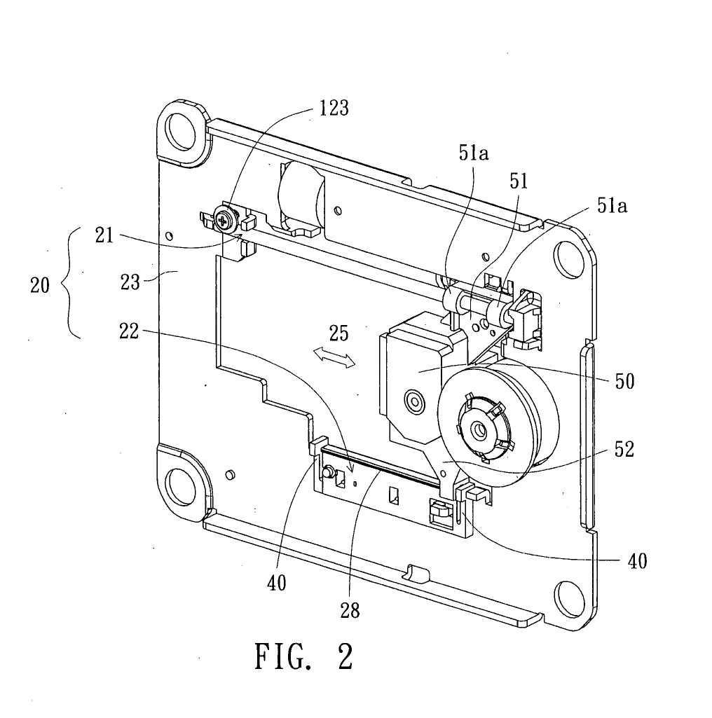

Referring to FIG. 2, an optical pickup unit and a carrying mechanism of an optical disc drive according to a preferred embodiment of the invention are shown. Examples of the optical disc drive include CD-ROM optical disc drive, DVD-ROM optical disc drive, CD writer, DVD writer, and COMBO drive. The optical disc drive includes an optical pickup unit 50 and a carrying element 20. The optical pickup unit 50 includes a first clamping portion 51 and a second clamping portion 52. The carrying mechanism 20 includes a mounting plate 23, a first guiding component 21 and a second guiding component 22. Examples of the material of the second guiding component 22 which include any materials having certain hardness are exemplified by plastics in the present embodiment of the invention.

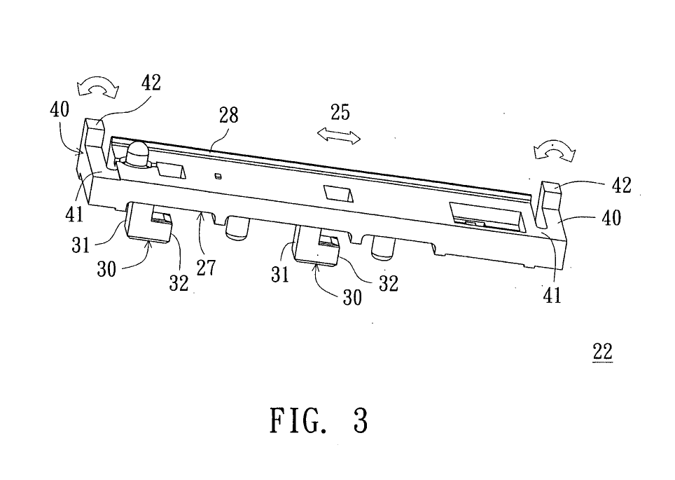

Referring to both FIG. 2 and FIG. 3, FIG. 3 is an enlarged diagram of the second guiding component in FIG. 2. The first guiding component 21 and the second guiding component 22 are respectively positioned on the two sides of the optical pickup unit 50. The optical pickup unit 50 is mounted on the first guiding component 21 and the second guiding component 22. The first guiding component 21 is a bar structure, and is locked on the mounting plate 23 via a screw 123. The first clamping portion 51 has at least a ring 51a. The first clamping portion 51 preferably has two rings 51a in the present embodiment of the invention. The first guiding component 21 penetrates the rings 51a of the first clamping portion 51 for enabling the first clamping portion 51 to slidably reciprocate along a first direction 25. The 15 second guiding component 22 is a plate structure, and further has a bar-shaped camshaft 28 disposed on the part of the plate structure close to one side of the first guiding component 21. The second clamping portion 52 is coupled to a bar-shaped camshaft 28 for enabling the second clamping portion 52 to slidably reciprocate along the first direction 25.

The second guiding component 22 further includes two elastomers 40 respectively disposed on the two ends of the second guiding component 22. The elastomer 40 includes a pivoting portion 41 and an elastic arm 42. The pivoting portion 41 is connected to one end of the second guiding component 22. The elastic arm 42, substantially perpendicular to the long side of the second guiding component 22, is connected to the pivoting portion 41. The elastic arm 42 can elastically swing around using the pivoting portion 41 as an axis. When the optical pickup unit 50 is slid to the end of the second guiding component 22, the second clamping portion 52 contacts and compresses the elastic arm 42 for enabling the elastic arm 42 to swing outward using the pivoting portion 41 as an axis. Meanwhile, a buffer is generated on the optical pickup unit 50 to mitigate the impact received by the optical pickup unit 50, so that the lifespan of the optical pickup unit 50 is prolonged.

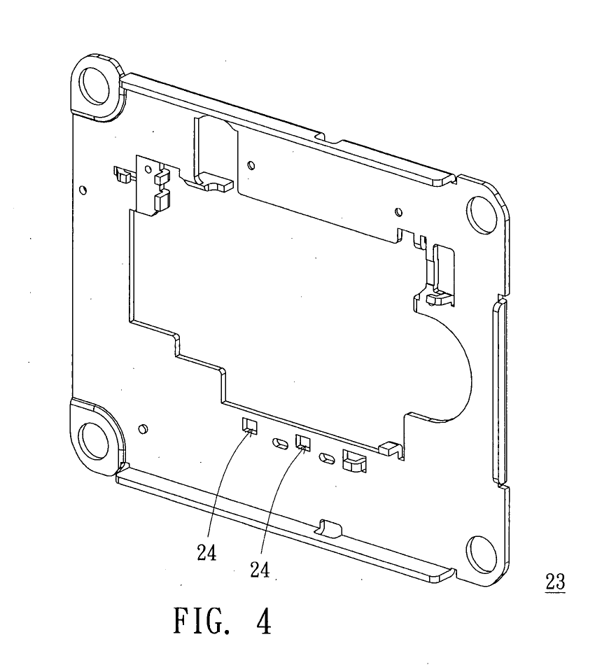

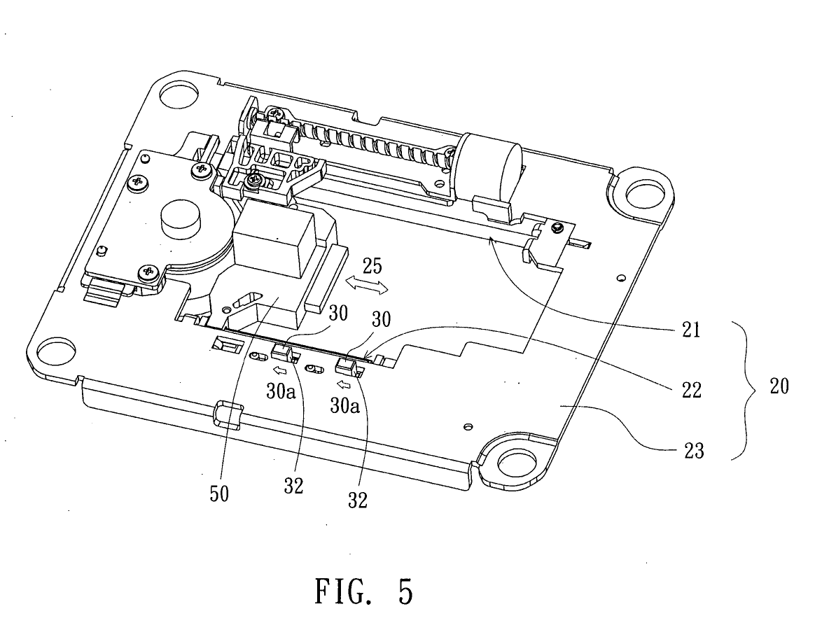

Referring to FIG. 3˜5, FIG. 4 illustrates the mounting plate in FIG. 2, and FIG. 5 illustrates a rear view of the optical pickup unit and the carrying mechanism in FIG. 2. The mounting plate 23 has two locking holes 24. The second guiding component 22 has two hooks 30 protruded from a first surface 27 of the second guiding component 22. The hook 30 includes a body portion 31 and an extending portion 32. The body portion 31 is disposed on the first surface 27. The extending portion 32 is connected to the body portion 31. The extending portion 32 and the body portion 31 form an L-shaped structure. After the hook 30 is plugged into the locking hole 24, the extending portion 32 continues to shift with respect to the locking hole 24 along an engaging direction 30a for enabling the hook 30 to be engaged inside the locking hole 24. The engaging direction 30a is preferably parallel to the first direction 25. Thus, the second guiding component 22 is firmly engaged with the mounting plate 23.

According to the above embodiment, despite the hook and the locking hole of the invention are exemplified in two sets and that the hook of the invention is exemplified in an L-shaped structure, however the second guiding component and the mounting plate of the invention can be incorporated with one set or multiple sets of the hook and the locking hole of other structure in different shapes. Any design of engaging mechanism enabling the second guiding component to be engaged with the mounting plate is within the scope of technology of the invention.

Moreover, according to the above embodiment, despite the elastomer of the invention is exemplified by an elastic arm and a second guiding component which are integrally formed in one piece; however the elastomer of the invention can also be exemplified by an elastic piece which is disposed on the second guiding component. Any design, which uses an elastic element or structure for enabling the elastomer to provide a buffer on the optical pickup unit to mitigate the impact received by the optical pickup unit when the optical pickup unit is slid to the two ends of the second guiding component, is within the scope of technology of the invention.

According to the above embodiment, despite the carrying mechanism of the invention is applied in an optical disc drive and an optical pickup unit using the same, however, the carrying mechanism of the invention is also applicable to other types of devices carrying an object. Any design of using a carrying device possessing the characteristics of the carrying device of the invention to carry an object is within the scope of technology of the invention.

According to the above embodiment, despite the invention is exemplified by enabling a plastic and plate structured second guiding component to be engaged with the mounting plate, however the invention can substitute plastics for the metal material of the first guiding component, and substitute an engaging mechanism disposed on the mounting plate for the screw. Any design using a mechanism to reduce the material cost and the labor of locking the screw is within the scope of technology of the invention.

The carrying mechanism and the optical disc drive using the same disclosed in the above embodiment of the invention substitute plastics for the metal materials of the first guiding component or the second guiding component, and substitute an engaging mechanism disposed the mounting plate for the screw, hence reducing the material cost and the labor of locking the screw. Moreover, the carrying mechanism adopts a structure of disposing an elastomer on the first guiding component or the second guiding component, hence reducing the impact received by the optical pickup unit when in use or during removal.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A carrying mechanism for carrying an object having a first clamping portion and a second clamping part, wherein the carrying mechanism comprise:
a mounting plate having a locking hole;
a first guiding component disposed on the mounting plate; and
a second guiding component disposed on the mounting plate;
wherein, at least one of the first guiding component and the second guiding component has a hook, at least one of the first guiding component and the second guiding component is a plate structure and has a first surface, the hook protruded from the first surface is plugged into the locking hole so that the first guiding component or the second guiding component is engaged with the mounting plate, and the first clamping portion or the second clamping portion is respectively coupled to the first guiding component or the second guiding component, for sliding the object along a first direction.

2. The carrying mechanism according to claim 1, wherein the hook comprise:
a body portion disposed on the first surface; and
an extending portion connected to the body portion, wherein the extending portion and the body portion form an L-shaped structure;
wherein, after the hook is plugged into the locking hole, the hook is engaged inside the locking hole through shifting or by an elastic force.

3. The carrying mechanism according to claim 1, wherein the first guiding component or the second guiding component which is plate structured further has a bar-shaped camshaft disposed at one side thereof, and the first clamping portion or the second clamping portion is coupled to the bar-shaped camshaft and slidably reciprocates along the bar-shaped camshaft.

4. The carrying mechanism according to claim 1, wherein the first guiding component or the second guiding component which is plate structured further comprises two elastomers disposed on two ends thereof, and wherein when the object slides to the two ends of the first guiding component or the second guiding component which is plate structured, the elastomers provide a buffer to the object to mitigate the impact received by the object.

5. The carrying mechanism according to claim 4, wherein each elastomer comprises:
a pivoting portion connected to one end of the first guiding component or the second guiding component which is plate structured; and
an elastic arm connected to the pivoting portion in a direction substantially perpendicular to the first direction, wherein the elastic arm elastically swings around using the pivoting portion as an axis.

6. The carrying mechanism according to claim 1, wherein the material of the first guiding component or the second guiding component which is plate structured is plastics.

7. The carrying mechanism according to claim 1, wherein the first guiding component and the second guiding component are parallel to each other and are respectively positioned on the two sides of the object.

8. An optical disc drive, comprising:
an optical pickup unit having a first clamping portion and a second clamping part; and
a carrying mechanism, comprising:
a mounting plate having a locking hole;
a first guiding component disposed on the mounting plate; and
a second guiding component disposed on the mounting plate;
wherein, at least one of the first guiding component and the second guiding component has a hook, at least one of the first guiding component and the second guiding component is a plate structure and has a first surface, the hook protruded from the first surface is plugged into the locking hole so that the first guiding component or the second guiding component is engaged with the mounting plate, and the first clamping portion or the second clamping portion is respectively coupled to the first guiding component or the second guiding component, for sliding the optical pickup unit along a first direction.

9. The optical disc drive according to claim 8, wherein the hook comprise:
a body portion disposed on the first surface; and
an extending portion connected to the body portion, wherein the extending portion and the body portion form an L-shaped structure;
wherein, after the hook is plugged into the locking hole, the hook is engaged inside the locking hole through shifting or by an elastic force.

10. The optical disc drive according to claim 8, wherein the first guiding component or the second guiding component which is plate structured further has a bar-shaped camshaft disposed at one side thereof, and the first clamping portion or the second clamping portion is coupled to the bar-shaped camshaft and slidably reciprocates along the bar-shaped camshaft.

11. The optical disc drive according to claim 8, wherein the first guiding component or the second guiding component which is plate structured further comprise two elastomers disposed on two ends thereof, and wherein when the optical pickup unit slides to the two ends of the first guiding component or the second guiding component which is plate structured, the elastomers provide a buffer to the optical pickup unit to mitigate the impact received by the optical pickup unit.

12. The optical disc drive according to claim 11, wherein each elastomer comprise:
a pivoting portion connected to one end of the first guiding component or the second guiding component which is plate structured; and
an elastic arm connected to the pivoting portion in a direction substantially perpendicular to the first direction, wherein the elastic arm elastically swings around using the pivoting portion as an axis.

13. The optical disc drive according to claim 8, wherein the material of the first guiding component or the second guiding component which is plate structured is plastics.

14. The optical disc drive according to claim 8, wherein the first guiding component and the second guiding component are parallel to each other and are respectively positioned on the two sides of the optical pickup unit.

15. The optical disc drive according to claim 8 is a CD-ROM optical disc drive, a DVD-ROM optical disc drive, a CD writer, a DVD writer or a COMBO drive.
